(19) United States
(12) Patent Application Publication
(10) Pub. No.: US 2024/0265750 A1
(43) Pub. Date: Aug. 8, 2024

(54) CONTROL APPARATUS

(71) Applicant: Mitsubishi Electric Corporation, Tokyo (JP)

(72) Inventor: Toshiki IKEGASHIRA, Tokyo (JP)

(73) Assignee: Mitsubishi Electric Corporation, Tokyo (JP)

(21) Appl. No.: 18/285,982

(22) PCT Filed: May 20, 2021
(86) PCT No.: PCT/JP2021/019205

§ 371 Date: Oct. 6, 2023

(51) Int. Cl. G07C 5/08; G07C 5/00

(52) U.S. Cl. CPC G07C 5/0808; G07C 5/008

(57) ABSTRACT

A control apparatus comprises: a control unit for executing control processing on a control target; a communications unit for transmitting and receiving communications data with respect to the control target; a storage unit for storing a memory of a control value(s) in the control unit, and that of control processing therein; a process monitoring unit for monitoring control processing of the control unit; a communications monitoring unit for monitoring communications data of the communications unit; a memory monitoring unit for monitoring a memory or memories of the storage unit; and an abnormality determination unit for performing determination whether or not control processing of the control unit is abnormal, from a monitoring result of the process monitoring unit, that of the communications monitoring unit and that of the memory monitoring unit.

### TECHNICAL FIELD

The disclosure of the present application relates to a control apparatus.

### BACKGROUND ART

In recent years, it can be found that on-vehicle or onboard systems of an automotive or motor vehicle are connected to a vehicle's exterior device(s) by way of a network(s), so that there arise a risk in which a third party having malicious intent makes unauthorized entry into the onboard system(s) from its outside by way of the network(s). If a third party makes unauthorized entry into the onboard system(s), there exists a possibility that, for example, in an ECU (Electronic Control Unit) being a control apparatus mounted on an automotive or motor vehicle, a program(s) of the ECU is tampered, and the control of the control apparatus is taken over by the third party, so that an accident of the motor vehicle might be lead to because it is remotely operated.

In a conventional onboard system, an abnormality handling method is conceivable in which, even when part of a device malfunctions, abnormality caused by the malfunction is detected, so that safe running can be achieved by degenerating a function(s) of the device by means of fail-safe, or by doing the like.

However, when a program(s) is tampered and a mechanism to detect abnormality is changed due to a malfunction, or when information being a subject matter of abnormality detection is disguised as if the information is of a normal value(s), it becomes difficult to detect abnormality as it is.

As a mechanism to detect abnormality of a motor vehicle which receives cyber-security attack, considerations have been underway for a mechanism to monitor communications data. As technologies for the security, there exist a technology of message authentication, that of a digital signature and/or the like, so that it is possible to detect abnormality due to communications data in disguise; however, those technologies belong to technologies to take countermeasures with respect to a known attack scenario, and so, it cannot be said that an unknown cyber-security attack can be coped with by those. When a program(s) is tampered, it becomes difficult to detect abnormality as it is; and thus, there arises the requirement to monitor not only the communications data, but also the behavior of the motor vehicle or that of its ECU(s).

As one of the countermeasures against unknown cyber-security attack, there exists a technology of secure boot; however, because of a memory check which is performed at the time of activation or a start-up, a motor vehicle cannot cope with an attack in a case in which the attack is received during the time when the motor vehicle is running. In addition, there arises a problem in that a process work-load becomes larger if a memory is checked at all times during the time when the motor vehicle is running. For dealing therewith, a mechanism is required in which, even when cyber-security attack is received not only at the time of activation or a start-up, but also during the time when a motor vehicle is running, abnormality is detected while a process work-load(s) of control processing is curbed, so that the motor vehicle is made being safely capable of running.

Patent Document 1 states that determination is performed, with respect to a control frame having been received, whether it is an abnormal frame or not within a predetermined time-period, and that an abnormal frame can be detected. In the control frame, a state frame of control state is included.

Patent Document 2 states that a monitoring method of communications data is changed in accordance with a state of a motor vehicle, and that, without increasing a work-load of data processing, abnormal data can be detected.

Patent Document 3 states that, from among a processing order of a sequence being an operational condition of an electronic control apparatus, an execution condition of the sequence, execution timing thereof, a control value(s) thereof, a communications item thereof and the like, another electronic control apparatus records an operational state, and that still another electronic control apparatus monitors the operational state, whereby abnormality can be detected in a case in which deviations occur from an ordinary state.

### RELATED ART DOCUMENTS

### Patent Documents

Patent Document 1: Japanese Patent Publication No. 6280662
Patent Document 2: Japanese Patent Publication No.
Patent Document 3: International Publication No. 2019/159615

### SUMMARY OF THE INVENTION

### Problems to be Solved by the Invention

In a conventional technology described in Patent Document 1, there arises such a problem as follows. In Patent Document 1, it is possible to detect abnormality of control frames f including a state frame of control state received from a communications channel; however, when control processing itself is tampered, there exists a possibility in that abnormality detection is escaped, or erroneous detection is performed.

In addition, in a conventional technology described in Patent Document 2, a monitoring method of communications data is changed in accordance with a state of a motor vehicle, whereby abnormal communications data can be detected while a process work-load is curbed; however, similarly to Patent Document 1, when control processing itself is tampered, there exists a possibility in that abnormality detection is escaped, or erroneous detection is performed.

In addition, in a conventional technology described in Patent Document 3, a processing order of a sequence, and/or a control value and a communications item are made to become monitoring subject matters; however, a memory is not made to become a monitoring subject matter to the extent. When the memory is tampered and when another new process has been added to within a process-step of a sequence, detection cannot be achieved when abnormality occurs in such a manner that a sequence passes through a normal route, and an intrinsic or primary control value is executed, so that an important value related to the control results in passing through the another new process in parallel with an intrinsic or primary sequence. Moreover, in order to detect abnormality which occurs at a process-step of a sequence, it is necessary to end the sequence. Furthermore, a process work-load is not taken into consideration. Because the configuration is taken in which two pieces of control apparatus are required for monitoring a control apparatus, it is not possible to detect abnormality by means of a single piece of control apparatus.

The present disclosure in the application concerned has been directed at solving those problems as described above, an object of the disclosure is to obtain a control apparatus in which communications data in control processing, a process (es) therein and a memory or memories therein are monitored, and optimum monitoring is performed while a process work-load(s) is curbed, whereby, even when cyber-security attack is received, abnormality of the communications data, that of the control processing and that of the memory or memories are detected, so that it is possible to detect abnormality of the control processing.

### Means for Solving the Problems

In a control apparatus disclosed in the disclosure of the application concerned which performs communications of data with respect to a control object or target in between, the control apparatus comprises: a control unit for executing control processing on the control target; a communications unit for transmitting and receiving communications data with respect to the control target; a storage unit for storing a memory of a control value(s) in the control unit, and that of control processing therein; a process monitoring unit for monitoring control processing of the control unit; a communications monitoring unit for monitoring communications data of the communications unit; a memory monitoring unit for monitoring a memory or memories of the storage unit; and an abnormality determination unit for performing determination whether or not control processing of the control unit is abnormal, from a monitoring result of the process monitoring unit, that of the communications monitoring unit and that of the memory monitoring unit.

### Effects of the Invention

According to the control apparatus disclosed in the disclosure of the application concerned, abnormality of communications data by cyber-security attack, or that of control processing thereby, or that of a memory thereby is detected, whereby abnormality of the control processing is detected, so that it is possible to safely control a control object or target.

### BRIEF DESCRIPTION OF DRAWINGS

FIG. 1 is a functional block diagram of a control apparatus according to Embodiment 1;

FIG. 2 is a diagram showing combinations of monitoring methods in which a monitoring management unit of the control apparatus according to Embodiment 1 determines;

FIG. 3 is a diagram showing combinations of monitoring methods of a communications monitoring unit in which the monitoring management unit of the control apparatus according to Embodiment 1 determines;

FIG. 4 is a diagram showing combinations of monitoring methods of a process monitoring unit in which the monitoring management unit of the control apparatus according to Embodiment 1 determines;

FIG. 5 is a diagram showing combinations of monitoring methods of a memory monitoring unit in which the monitoring management unit of the control apparatus according to Embodiment 1 determines;

FIG. 6 is a flowchart showing control processing of the control apparatus according to Embodiment 1;

FIG. 7 is a flowchart showing abnormality determination processing of the control apparatus according to Embodiment 1;

FIG. 8 is a flowchart showing the processing of determining monitoring methods in the control apparatus according to Embodiment 1; and

FIG. 9 is a diagram showing, by way of one example, a hardware configuration of the control apparatus according to Embodiment 1.

### EMBODIMENTS FOR CARRYING OUT THE INVENTION

Hereinafter, the explanation will be made referring to the drawings for the preferred exemplary embodiments of a control apparatus disclosed in the disclosure of the application concerned. Note that, hereinafter, the explanation will be made in detail for a case as a specific example of the control apparatus which is applied to an onboard control apparatus (ECU) whose control object(s) or target(s) is defined as an automotive or motor vehicle, and as onboard devices or apparatus.

### Embodiment 1

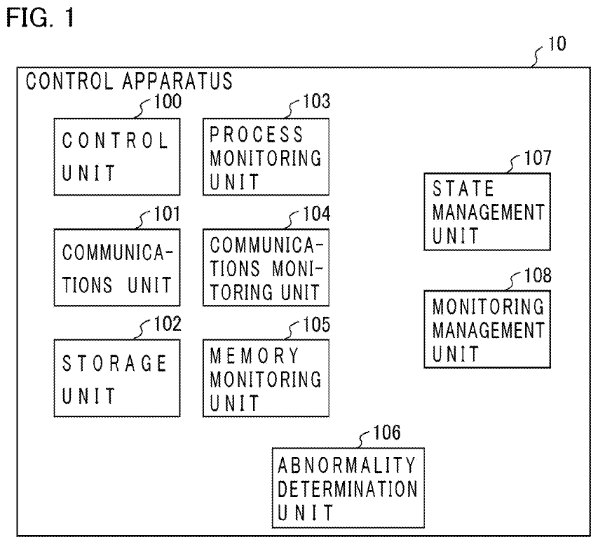

FIG. 1 is a functional block diagram of an onboard control apparatus (ECU) to which a control apparatus according to Embodiment 1 is applied. The onboard control apparatus (ECU) (hereinafter, referred to as a control apparatus 10) in Embodiment 1 is constituted of a control unit 100, a communications unit 101, a memory or storage unit 102, a process monitoring unit 103, a communications monitoring unit 104, a memory monitoring unit 105, an abnormality determination unit 106, a state management unit 107 and a monitoring management unit 108, which are provided with the control apparatus.

The control apparatus 10 is an onboard control apparatus for performing the control of an automotive or motor vehicle. The control apparatus 10 is connected to another control apparatus in the interior of a motor vehicle (for example, to a standby control apparatus, an electric power steering apparatus, and the like) by way of a communications line(s), for example, a CAN (Controller Area Network), though which are not shown in the figure.

The control unit 100 has the function to control devices or apparatus on a control object(s) or target(s) mounted on within the motor vehicle. It may also be so arranged that such a control unit 100 exists in the control apparatus 10 in a single or a plurality of control units. Note that, in FIG. 1, devices or apparatus on a control object(s) or target(s) are not shown in the figure; and so, in the following explanation, a device or apparatus on the control target is simply referred to as a “control target.” The control target mounted on within the motor vehicle is an actuator, for example.

To be specific, the control unit 100 reads out a piece(s) of controlling program data corresponding to a control target from a ROM(s) of the storage unit 102 and a RAM(s) thereof, and executes a program(s) having been read out from the storage unit, whereby the control is performed on the control target. In addition, it may also be so arranged that such a control method exists in a plurality of control methods.

The communications unit 101 has the functions to transmit and receive communications data with respect to another control apparatus in between. For example, such functions include the functions to transmit and receive communications data of CAN communications.

The storage unit 102 is provided with a memory or memories which record an operational program(s) being control processing of the control unit 100, and its control value(s) used at the time of its operations. The memory or memories include a ROM(s) and/or a RAM(s).

The process monitoring unit 103 acquires an execution procedure(s) of control processing for use in the control unit 100, or an execution number thereof, or an execution time(s) thereof. In addition, another piece or other pieces of information may be acquired. The control processing being defined as a subject matter may also be overall control processing, or partial processing.

The communications monitoring unit 104 acquires a communications ID of communications data received by the communications unit 101, a data length thereof, a data value(s) thereof, the quantity of change of the data value(s) thereof, a communications period thereof, and a communications frequency thereof. In addition, another piece or other pieces of information may be added to.

The memory monitoring unit 105 acquires a memory of a control value(s) stored by the storage unit 102, or that of the control processing stored thereby. In addition, another piece or other pieces of information may be added to. Moreover, the memory data may be acquired by compressing it, where the data undergoes hashing or the like.

The abnormality determination unit 106 compares a monitoring result of the process monitoring unit 103, that of the communications monitoring unit 104 and that of the memory monitoring unit 105 with respective normal values. As for the normal values, the values to become as the monitoring subject matters with respect to the process monitoring unit 103 at the time of its normal operations, the communications monitoring unit 104 thereat and the memory monitoring unit 105 thereat are kept in storage in a ROM(s) of the storage unit 102 or a RAM(s) thereof in advance.

It may be so arranged that, when a monitoring result of the memory monitoring unit 105 is compared with a normal value, the abnormality determination unit 106 performs whether or not the comparison of coincidence is held by dividing a memory into pieces. In addition, the memory data may also be compared by compressing it, where the data undergoes hashing or the like. In order to achieve security reinforcement and/or high-speed performance of the processing, the comparison may still be performed by an HSM (Hardware Security Module).

The abnormality determination unit 106 determines abnormality, when a comparison result of a monitoring result is not coincident with a normal value. The requirement of determining abnormality is any one of a comparison result in a case in which a monitoring result of the communications monitoring unit 104 is not coincident with a normal value, or a case in which a monitoring result of the process monitoring unit 103 is not coincident with a normal value, or a case in which a monitoring result of the memory monitoring unit 105 is not coincident with a normal value.

When abnormality is determined, the abnormality determination unit 106 may move to abnormality countermeasure processing. The abnormality countermeasure processing includes, for example, a changeover of a communications line(s), a changeover to a standby control apparatus, functional degeneracy of a control apparatus, and the like. When normality is determined, ordinary control processing of the control unit 100 is continuously executed.

The state management unit 107 acquires a state(s) of a motor vehicle. Acquired is any one of states among: a control state of the control apparatus 10, a control state of a motor vehicle control system, a neighboring environment state of a motor vehicle, location information of a motor vehicle, a communications state of the control apparatus 10, a state of an operator or driver within a motor vehicle, a process work-load state in the control apparatus 10, and a cyber-security attack state with respect to the control apparatus 10.

To be specific, a control state of the control apparatus 10 indicates an activation or start-up state of the control apparatus 10, a sleep state thereof, and/or the like. In addition, another state thereof may also be acquired.

To be specific, a control state of a motor vehicle control system indicates such an operational state as running in motor vehicle's motion, turning therein or stopping therein. In addition, another state thereof may also be acquired.

To be specific, a neighboring environment state of a motor vehicle indicates a traffic situation such as congestion or the like, and/or the weather such as snow or the like. In addition, another state thereof may also be acquired.

To be specific, location information of a motor vehicle indicates that the motor vehicle is within a tunnel, it is at an intersection and/or the like. In addition, another state may also be acquired.

To be specific, a communications state of the control apparatus 10 indicates whether the control apparatus 10 is during communicating with, or it is not during communicating with. In addition, the communications state thereof may be finely classified.

To be specific, a state of an operator or driver within a motor vehicle indicates a state in which the driver is sleeping, tired, or being the like. In addition, another state thereof may also be acquired.

To be specific, a process work-load state in the control apparatus 10 indicates whether there is an allowance or margin for the processing when a process work-load in the control apparatus 10 is small, whether there is no margin for the processing when the process work-load is large, or the like. In addition, the process work-load state therein may be finely classified.

To be specific, when abnormality is determined by the abnormality determination unit 106, a cyber-security attack state with respect to the control apparatus 10 indicates whether the control apparatus is in a communications abnormality state in accordance with a monitoring result of the communications monitoring unit 104, or whether the control apparatus is in a processing abnormality state in accordance with a monitoring result of the process monitoring unit 103, or whether the control apparatus is in a memory abnormality state in accordance with a monitoring result of the memory monitoring unit 105.

The monitoring management unit 108 determines, in accordance with a state(s) acquired by the state management unit 107, a monitoring method of the process monitoring unit 103, that of the communications monitoring unit 104, and that of the memory monitoring unit 105; and the monitoring management unit determines respective degrees of priority of these monitoring methods. For example, when a communications state of the control apparatus 10 is in a state during communicating with, it is necessary to detect whether or not abnormal communications data is received, and thus, a priority is given to communications monitoring. When a control state of a motor vehicle control system is in that during running, a priority is given to process monitoring because of not causing an abnormal process (es); and, when the state thereof is in that during stopping, a priority is given to memory monitoring because of having an allowance or margin relatively in a process work-load. As for these states, another state thereof may be added to, or a state may be modified.

The monitoring management unit 108 assigns a priority in such a manner that, in accordance with a state acquired by the state management unit 107, the priority is given to communications monitoring in a case of a communications abnormality state, that the priority is given to process monitoring in a case of a processing abnormality state, and that the priority is given to memory monitoring in a case of a memory abnormality state.

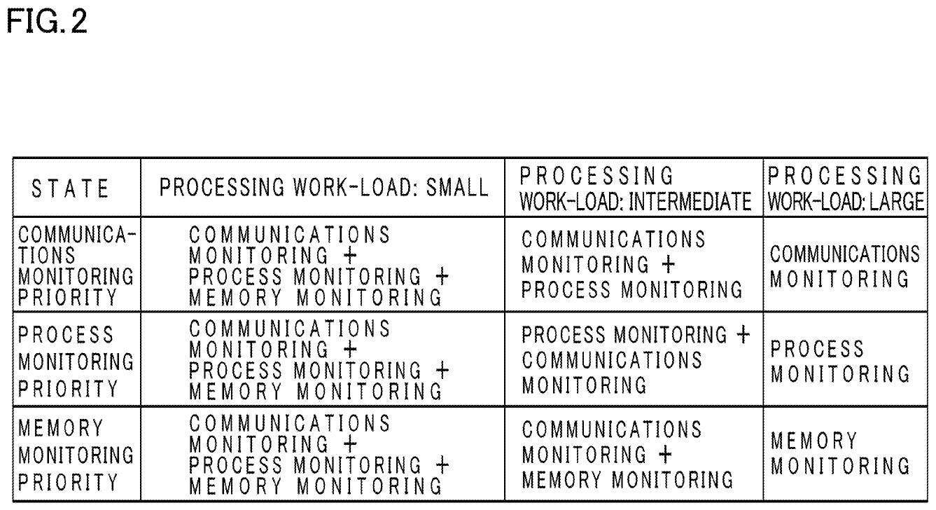

The monitoring management unit 108 determines, in accordance with a process work-load state in the control apparatus 10 and the degree of priority therein, any one monitoring method by means of monitoring on only the process monitoring unit 103, monitoring on only the communications monitoring unit 104 or monitoring on only the memory monitoring unit 105, or by means of monitoring on a combination among the process monitoring unit 103, the communications monitoring unit 104 and the memory monitoring unit 105. Combinations among these monitoring methods and their degrees of priority are shown in FIG. 2. The combinations among these monitoring methods may be modified in accordance with a process work-load(s).

The monitoring management unit 108 determines a monitoring method of the process monitoring unit 103, that of the communications monitoring unit 104 and that of the memory monitoring unit 105 in accordance with their respective degrees of priority.

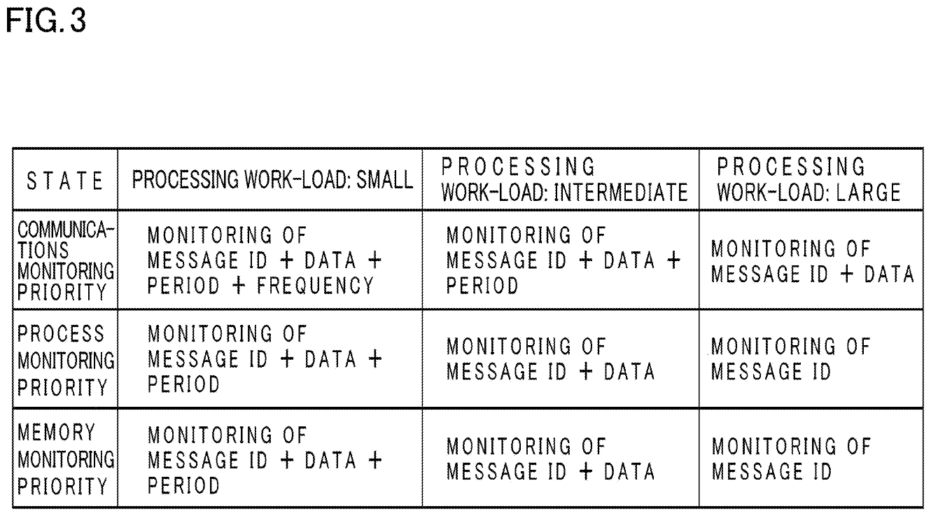

Monitoring methods of the communications monitoring unit 104 whose priorities are assigned in accordance with motor vehicle states are shown in FIG. 3. When a priority is given to communications monitoring in accordance with a state acquired by the state management unit 107 because the control apparatus 10 is in a state during communicating with, or because the control apparatus is in a communications abnormality state, the monitoring is performed by assigning the priority on a communications monitoring item(s). As monitoring items of the communications data, a message ID, data, a period and the frequency are monitored. The number of monitoring items is altered in accordance with a process work-load(s). These monitoring items may be modified and/or added to in accordance with a process work-load(s). In addition, a state in which a priority is given to the communications monitoring may be another state.

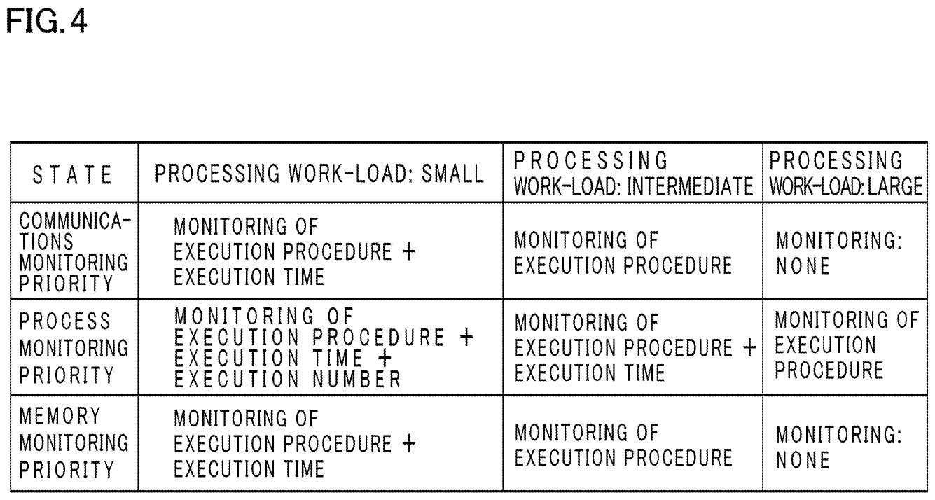

Monitoring methods of the process monitoring unit 103 whose priorities are assigned in accordance with motor vehicle states are shown in FIG. 4. When a priority is given to process monitoring in accordance with a state acquired by the state management unit 107 because a motor vehicle is during running or in a processing abnormality state, the monitoring is performed by assigning the priority on a process monitoring item(s). As monitoring items of the control processing, an execution order, an execution time(s) and an execution number are monitored. The number of monitoring items is altered in accordance with a process work-load(s). These monitoring items may be modified and/or added to in accordance with a process work-load(s). In addition, a state in which a priority is given to the process monitoring may be another state.

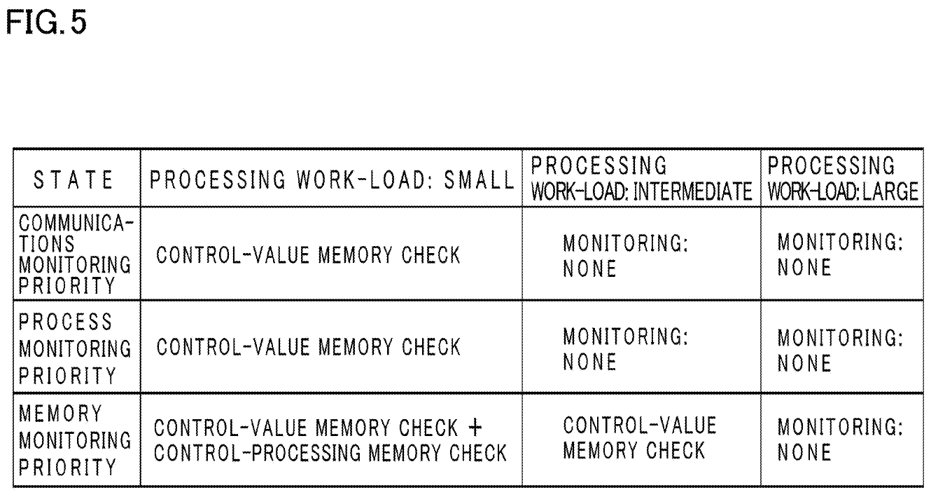

Monitoring methods of the memory monitoring unit 105 whose priorities are assigned in accordance with motor vehicle states are shown in FIG. 5. When a priority is given to memory monitoring in accordance with a state acquired by the state management unit 107 because a motor vehicle is during stopping or in a memory abnormality state, the monitoring is performed by assigning the priority on a memory monitoring item(s). As monitoring items of the memories, a memory of a control value(s) and that of control processing are monitored. The number of monitoring items is altered in accordance with a process work-load(s). In addition, when a process work-load is large and the processing cannot be achieved, it may be possible not to perform the monitoring. These monitoring items may be modified and/or added to in accordance with a process work-load(s). Moreover, a state in which a priority is given to the memory monitoring may be another state.

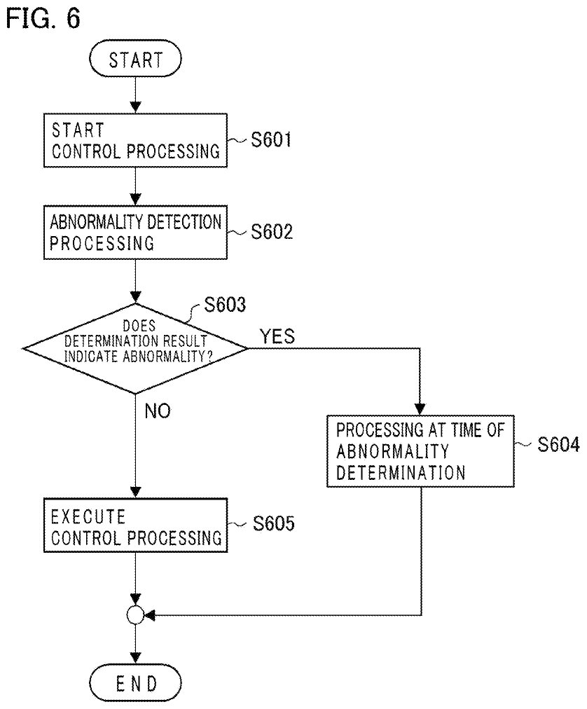

Next, the explanation will be made in detail referring to FIG. 6 for control processing of the control apparatus 10. FIG. 6 is a flowchart showing the flows of the processing, commencing from a control's start of the control unit 100 according to Embodiment 1, until control processing of the control unit 100 is executed while passing through abnormality detection processing.

At Step S601, the control unit 100 starts its control processing. After finishing Step S601, the processing proceeds to Step S602.

At Step S602, abnormality detection processing is executed. After finishing Step S602, the processing proceeds to Step S603.

At Step S603, the processing proceeds to Step S604, when abnormality of the control apparatus is determined in accordance with a result of the abnormality detection processing. When normality of the control apparatus is determined in accordance with a result of the abnormality detection processing, the processing proceeds to Step S605.

At Step S604, the processing at the time of abnormality determination is executed.

At Step S605, the control processing is executed in the control unit 100. After finishing Step S605, the control processing is ended.

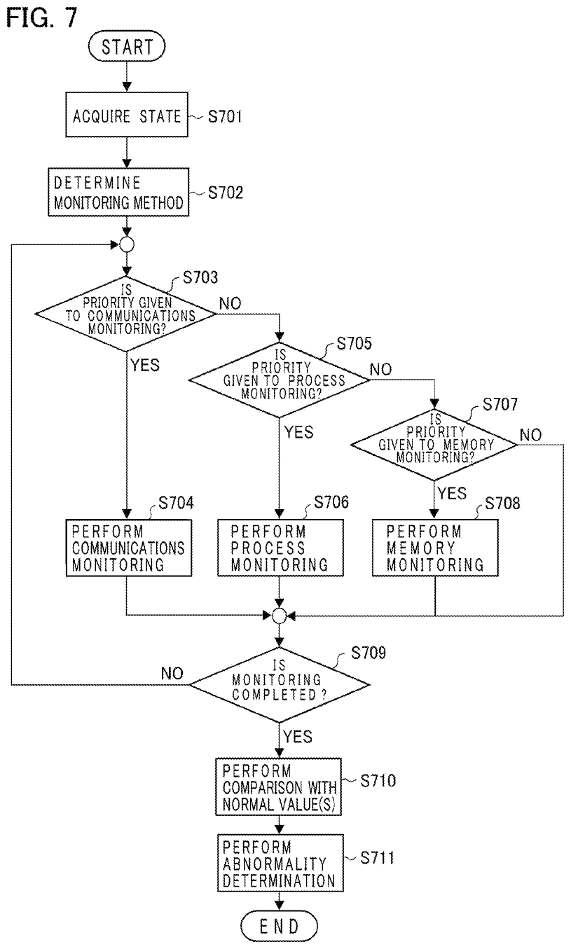

Next, the explanation will be made in detail referring to FIG. 7 for Step S602 of abnormality detection processing in FIG. 6. FIG. 7 is a flowchart showing the flows of abnormality detection processing of the control apparatus 10 according to Embodiment 1.

At Step S701, the state management unit 107 acquires a motor vehicle state. After finishing Step S701, the processing proceeds to Step S702.

At Step S702, the monitoring management unit 108 determines, in accordance with a state acquired by the state management unit 107, a monitoring method and the degree of priority of the monitoring method. After finishing Step S702, the processing proceeds to Step S703.

At Step S703, when a priority is given to communications monitoring at Step S702, the processing proceeds to Step S704. When a priority is not given to the communications monitoring, the processing proceeds to Step S705.

At Step S704, the communications monitoring unit 104 monitors communications data. After finishing Step S704, the processing proceeds to Step S709.

At Step S705, when a priority is given to process monitoring at Step S702, the processing proceeds to Step S706. When a priority is not given to the process monitoring, the processing proceeds to Step S707.

At Step S706, the process monitoring unit 103 monitors the control processing. After finishing Step S706, the processing proceeds to Step S709.

At Step S707, when a priority is given to memory monitoring at Step S702, the processing proceeds to Step S708. When a priority is not given to the memory monitoring, the processing proceeds to Step S709.

At Step S708, the memory monitoring unit 105 monitors a memory or memories. After finishing Step S708, the processing proceeds to Step S709.

At Step S709, the processing returns to Step S703, when there exists a plurality of monitoring methods for the communications monitoring, process monitoring and memory monitoring at Step S702, and also when the processing for them is not completed. When the processing for them is completed, the processing proceeds to Step S710.

At Step S710, the comparisons are performed whether a monitoring result at Step S704 is coincident with a normal value, or whether a monitoring result at Step S706 is coincident with a normal value, or whether a monitoring result at Step S708 is coincident with a normal value. After finishing Step S710, the processing proceeds to Step S711.

At Step S711, it is determined that the control apparatus is normal when comparison results at Step S710 are coincident with respective normal values, whereas it is determined that the control apparatus is abnormal when the comparison results are not coincident with the respective normal values. After finishing Step S711, the abnormality detection processing is ended.

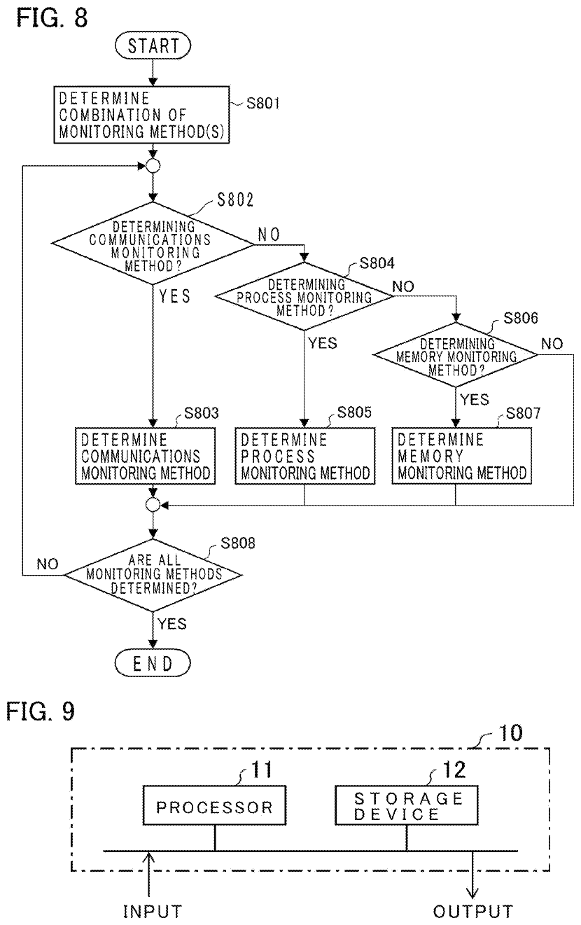

Next, the explanation will be made in detail referring to FIG. 8 for Step S702 of monitoring-method determination processing in FIG. 7. FIG. 8 is a flowchart showing the processing flows of determining monitoring methods of the monitoring management unit 108 in the control apparatus 10 according to Embodiment 1.

At Step S801, the monitoring management unit 108 determines the degree of priority of communications monitoring, that of process monitoring and that of memory monitoring on the basis of a motor vehicle state acquired by the state management unit 107, and determines a monitoring method(s). After finishing Step S801, the processing proceeds to Step S802.

At Step S802, the processing proceeds to Step S803, when the monitoring management unit 108 determines at Step S801 that communications monitoring is required. When it is determined at Step S801 that the communications monitoring is not required, the processing proceeds to Step S804.

At Step S803, the monitoring management unit 108 determines a monitoring method of the communications monitoring on the basis of a motor vehicle state acquired by the state management unit 107. After finishing Step S803, the processing proceeds to Step S808.

At Step S804, the processing proceeds to Step S805, when the monitoring management unit 108 determines at Step S801 that process monitoring is required. When it is determined at Step S801 that the process monitoring is not required, the processing proceeds to Step S806.

At Step S805, the monitoring management unit 108 determines a monitoring method of the process monitoring on the basis of a motor vehicle state acquired by the state management unit 107. After finishing Step S805, the processing proceeds to Step S808.

At Step S806, the processing proceeds to Step S807, when the monitoring management unit 108 determines at Step S801 that memory monitoring is required. When it is determined at Step S801 that the memory monitoring is not required, the processing proceeds to Step S808.

At Step S807, the monitoring management unit 108 determines a monitoring method of the memory monitoring on the basis of a motor vehicle state acquired by the state management unit 107. After finishing Step S807, the processing proceeds to Step S808.

At Step S808, when all of monitoring methods are not determined, the processing returns to Step S802. When all of the monitoring methods are determined, the monitoring-method determination processing is ended.

It should be noted that, as an example of hardware is shown in FIG. 9, the control apparatus 10 is constituted of a processor 11 and a memory or storage device 12. The storage device 12 is provided with a volatile storage device of a random access memory (RAM) or the like, and with a nonvolatile auxiliary storage device of a flash memory or the like, for example. In addition, in place of the flash memory, an auxiliary storage device of a hard disk may be provided with. The processor 11 executes a program(s) inputted from the storage device 12. In this case, the program(s) is inputted into the processor 11 from the auxiliary storage device by way of the volatile storage device. Moreover, the processor 11 may output its data of a calculated result(s) or the like into the volatile storage device of the storage device 12, or may store the data into the auxiliary storage device by way of the volatile storage device.

Note that, in Embodiment 1 described above, the explanation has been made, by way of example, for the control apparatus which is used as an onboard control apparatus. However, the control apparatus disclosed in the disclosure of the application concerned is not necessarily limited to the onboard one. For example, it is possible to utilize for a control apparatus connected to a communications line(s) which requires a mechanism having a high degree of security strength, and also the mechanism detecting abnormality of the control apparatus at an early stage.

In accordance with Embodiment 1 according to the disclosure of the application concerned described above, effects can be achieved in the control processing as obtaining those described below.

In a conventional control apparatus, the apparatus adopts an abnormality detection method focusing on communications data, and/or an abnormality detection method focusing on control processing. On the other hand, the control apparatus according to Embodiment 1 monitors communications data and/or a control value(s), control processing, and a memory or memories, and compares whether or not a monitoring result is coincident with a normal value, whereby the control apparatus is provided with the configuration to detect abnormality of the control apparatus.

According to this arrangement, even when communications data undergoes its disguise by cyber-security attack and/or when a control value(s) and the control processing undergo their disguise thereby, and/or even when a memory or memories are tampered, it becomes possible to detect abnormality.

In addition, the control apparatus according to Embodiment 1 comprises the state management unit for acquiring a motor vehicle state, and the monitoring management unit for performing determination on a monitoring method to which a priority should be given in accordance with a motor vehicle state; and the control apparatus comprises the configuration in which monitoring methods can be changed over or combined with one another in accordance with the motor vehicle state. According to this arrangement, it becomes possible to achieve an optimum monitoring while a process work-load is curbed.

Moreover, the control apparatus to according Embodiment 1 is provided with the configuration in which it is possible to cope with a plurality of monitoring methods among monitoring on only communications data, monitoring on only control processing, monitoring on only a memory or memories, monitoring by means of a combination of the communications data, the control processing, and the memory or memories. According to this arrangement, it becomes possible to combine monitoring methods with one another in accordance with a process work-load(s).

Still moreover, the control apparatus according to Embodiment 1 is provided with the configuration in which determination is performed in accordance with a motor vehicle state on a monitoring method of communications data to which a priority should be given, on a monitoring method of control processing to which a priority should be given, and on a monitoring method of a memory or memories to which a priority should be given. According to this arrangement, it becomes possible to achieve monitoring of communications data in accordance with a process work-load, monitoring of control processing in accordance with a process work-load, and monitoring of a memory or memories in accordance with a process work-load.

Yet moreover, the control apparatus according to Embodiment 1 is provided with the configuration in which monitoring is performed by assigning a priority on the communications monitoring unit, when the control apparatus is during communicating with. According to this arrangement, it becomes possible to detect abnormality of communications data.

Yet still moreover, the control apparatus according to Embodiment 1 is provided with the configuration in which monitoring is performed by assigning a priority on the process monitoring unit, when a motor vehicle is during running. According to this arrangement, it is possible to detect abnormality of control processing.

Furthermore, the control apparatus according to Embodiment 1 is provided with the configuration in which monitoring is performed by assigning a priority on the memory monitoring unit, when a motor vehicle is during stopping. According to this arrangement, it becomes possible to detect tampering of a memory or memories.

Still furthermore, the control apparatus according to Embodiment 1 is provided with the configuration in which a communications monitoring result, a process monitoring result and a memory monitoring result are compared with a communications monitoring value at a normal time, a process monitoring value thereat and a memory monitoring value thereat, respectively. According to this arrangement, when a value(s) at the normal time is not coincident with a monitoring result(s), it becomes possible to detect abnormality of the control apparatus.

Yet furthermore, the control apparatus according to Embodiment 1 is provided with the configuration by which it is possible to acquire a state whether cyber-security attack is received or not. According to this arrangement, it becomes possible to detect abnormality of the control apparatus even after cyber-security attack.

In the present disclosure of the application concerned, exemplary embodiments are described; however, various features, aspects and functions described in the embodiments are not necessarily limited to the applications of a specific embodiment(s), but are applicable in an embodiment(s) solely or in various combinations.

Therefore, limitless modification examples not being exemplified can be presumed without departing from the scope of the technologies disclosed in Description of the disclosure of the application concerned. For example, there arises such a case that is included as a case in which at least one constituent element of another embodiment is modified, or added thereto or eliminated therefrom.

### EXPLANATION OF NUMERALS AND SYMBOLS

Numeral “10” designates a control apparatus; “100,” control unit; “101,” communications unit; “102,” storage unit; “103,” process monitoring unit; “104,” communications monitoring unit; “105,” memory monitoring unit; “106,” abnormality determination unit; “107,” state management unit; and “108,” monitoring management unit.

1-9. (canceled)

10. A control apparatus which performs communications of data with respect to a control target in between, the control apparatus, comprising:
a controller for executing control processing on the control target;
a communications circuitry for transmitting and receiving communications data with respect to the control target;
a storage circuitry for storing a memory of a control value in the controller, and that of control processing therein;
a process monitoring circuitry for monitoring control processing of the controller;
a communications monitoring circuitry for monitoring communications data of the communications circuitry;
a memory monitoring circuitry for monitoring a memory of the storage circuitry; and
an abnormality determination circuitry for performing determination whether or not control processing of the controller is abnormal, from a monitoring result of the process monitoring circuitry, that of the communications monitoring circuitry and that of the memory monitoring circuitry.

11. The control apparatus as set forth in claim 10, being the control apparatus of a motor vehicle control system for controlling running of a motor vehicle, the control apparatus, further comprising:
a state management circuitry for acquiring any one state among a control state of the controller, a control state of the motor vehicle control system, a neighboring environment state of a motor vehicle, location information of a motor vehicle, a communications state with respect to a motor vehicle, a state of a driver within a motor vehicle, a state of a process work-load in the controller and an attack state of the motor vehicle control system; and
a monitoring management circuitry for determining, in accordance with the any one state, a monitoring method and a degree of priority thereof on the process monitoring circuitry, a monitoring method and a degree of priority thereof on the communications monitoring circuitry, and a monitoring method and a degree of priority thereof on the memory monitoring circuitry.

12. The control apparatus as set forth in claim 11, wherein the monitoring management circuitry determines, in accordance with a monitoring method and a degree of priority thereof, a monitoring method by any one combination of monitoring on only the communications monitoring circuitry, monitoring on only the process monitoring circuitry or monitoring on only the memory monitoring circuitry, or a monitoring method by a combination of monitoring on among the communications monitoring circuitry, the process monitoring circuitry and the memory monitoring circuitry.

13. The control apparatus as set forth in claim 11, wherein
the monitoring management circuitry determines, in accordance with a monitoring method and a degree of priority thereof, a monitoring method by any one combination made among the communications monitoring circuitry, the process monitoring circuitry and the memory monitoring circuitry; and also
the monitoring management circuitry determines a monitoring method of communications data in the communications monitoring circuitry, a monitoring method of control processing in the process monitoring circuitry, and a monitoring method of a memory of a control value in the memory monitoring circuitry and that of control processing therein.

14. The control apparatus as set forth in claim 12, wherein
the monitoring management circuitry determines, in accordance with a monitoring method and a degree of priority thereof, a monitoring method by any one combination made among the communications monitoring circuitry, the process monitoring circuitry and the memory monitoring circuitry; and also
the monitoring management circuitry determines a monitoring method of communications data in the communications monitoring circuitry, a monitoring method of control processing in the process monitoring circuitry, and a monitoring method of a memory of a control value in the memory monitoring circuitry and that of control processing therein.

15. The control apparatus as set forth in claim 11, wherein
the monitoring management circuitry assigns a degree of priority of the communications monitoring circuitry higher than another monitoring circuitry, when the control apparatus is in a state during communicating with according to the state management circuitry;
the monitoring management circuitry determines, in accordance with a state of a process work-load according to the state management circuitry in the control apparatus, any one monitoring method by a combination made among monitoring on only the communications monitoring circuitry, monitoring on only the communications monitoring circuitry and the process monitoring circuitry, monitoring on only the communications monitoring circuitry and the memory monitoring circuitry, and monitoring on the communications monitoring circuitry, the process monitoring circuitry and the memory monitoring circuitry; and also
the monitoring management circuitry determines a monitoring method of communications data in the communications monitoring circuitry.

16. The control apparatus as set forth in claim 12, wherein
the monitoring management circuitry assigns a degree of priority of the communications monitoring circuitry higher than another monitoring circuitry, when the control apparatus is in a state during communicating with according to the state management circuitry;
the monitoring management circuitry determines, in accordance with a state of a process work-load according to the state management circuitry in the control apparatus, any one monitoring method by a combination made among monitoring on only the communications monitoring circuitry, monitoring on only the communications monitoring circuitry and the process monitoring circuitry, monitoring on only the communications monitoring circuitry and the memory monitoring circuitry, and monitoring on the communications monitoring circuitry, the process monitoring circuitry and the memory monitoring circuitry; and also
the monitoring management circuitry determines a monitoring method of communications data in the communications monitoring circuitry.

17. The control apparatus as set forth in claim 13, wherein
the monitoring management circuitry assigns a degree of priority of the communications monitoring circuitry higher than another monitoring circuitry, when the control apparatus is in a state during communicating with according to the state management circuitry;
the monitoring management circuitry determines, in accordance with a state of a process work-load according to the state management circuitry in the control apparatus, any one monitoring method by a combination made among monitoring on only the communications monitoring circuitry, monitoring on only the communications monitoring circuitry and the process monitoring circuitry, monitoring on only the communications monitoring circuitry and the memory monitoring circuitry, and monitoring on the communications monitoring circuitry, the process monitoring circuitry and the memory monitoring circuitry; and also
the monitoring management circuitry determines a monitoring method of communications data in the communications monitoring circuitry.

18. The control apparatus as set forth in claim 14, wherein
the monitoring management circuitry assigns a degree of priority of the communications monitoring circuitry higher than another monitoring circuitry, when the control apparatus is in a state during communicating with according to the state management circuitry;
the monitoring management circuitry determines, in accordance with a state of a process work-load according to the state management circuitry in the control apparatus, any one monitoring method by a combination made among monitoring on only the communications monitoring circuitry, monitoring on only the communications monitoring circuitry and the process monitoring circuitry, monitoring on only the communications monitoring circuitry and the memory monitoring circuitry, and monitoring on the communications monitoring circuitry, the process monitoring circuitry and the memory monitoring circuitry; and also
the monitoring management circuitry determines a monitoring method of communications data in the communications monitoring circuitry.

19. The control apparatus as set forth in claim 11, wherein
the monitoring management circuitry assigns a degree of priority of the process monitoring circuitry higher than another monitoring circuitry, when a motor vehicle is in a state during running according to the state management circuitry;
the monitoring management circuitry determines, in accordance with a state of a process work-load according to the state management circuitry in the control apparatus, any one monitoring method by a combination made among monitoring on only the process monitoring circuitry, monitoring on only the process monitoring circuitry and the communications monitoring circuitry, monitoring on only the process monitoring circuitry and the memory monitoring circuitry, and monitoring on the communications monitoring circuitry, the process monitoring circuitry and the memory monitoring circuitry; and also
the monitoring management circuitry determines a monitoring method of control processing in the process monitoring circuitry.

20. The control apparatus as set forth in claim 12, wherein
the monitoring management circuitry assigns a degree of priority of the process monitoring circuitry higher than another monitoring circuitry, when a motor vehicle is in a state during running according to the state management circuitry;
the monitoring management circuitry determines, in accordance with a state of a process work-load according to the state management circuitry in the control apparatus, any one monitoring method by a combination made among monitoring on only the process monitoring circuitry, monitoring on only the process monitoring circuitry and the communications monitoring circuitry, monitoring on only the process monitoring circuitry and the memory monitoring circuitry, and monitoring on the communications monitoring circuitry, the process monitoring circuitry and the memory monitoring circuitry; and also
the monitoring management circuitry determines a monitoring method of control processing in the process monitoring circuitry.

21. The control apparatus as set forth in claim 13, wherein
the monitoring management circuitry assigns a degree of priority of the process monitoring circuitry higher than another monitoring circuitry, when a motor vehicle is in a state during running according to the state management circuitry;
the monitoring management circuitry determines, in accordance with a state of a process work-load according to the state management circuitry in the control apparatus, any one monitoring method by a combination made among monitoring on only the process monitoring circuitry, monitoring on only the process monitoring circuitry and the communications monitoring circuitry, monitoring on only the process monitoring circuitry and the memory monitoring circuitry, and monitoring on the communications monitoring circuitry, the process monitoring circuitry and the memory monitoring circuitry; and also
the monitoring management circuitry determines a monitoring method of control processing in the process monitoring circuitry.

22. The control apparatus as set forth in claim 14, wherein
the monitoring management circuitry assigns a degree of priority of the process monitoring circuitry higher than another monitoring circuitry, when a motor vehicle is in a state during running according to the state management circuitry;
the monitoring management circuitry determines, in accordance with a state of a process work-load according to the state management circuitry in the control apparatus, any one monitoring method by a combination made among monitoring on only the process monitoring circuitry, monitoring on only the process monitoring circuitry and the communications monitoring circuitry, monitoring on only the process monitoring circuitry and the memory monitoring circuitry, and monitoring on the communications monitoring circuitry, the process monitoring circuitry and the memory monitoring circuitry; and also
the monitoring management circuitry determines a monitoring method of control processing in the process monitoring circuitry.

23. The control apparatus as set forth in claim 11, wherein
the monitoring management circuitry assigns a degree of priority of the memory monitoring circuitry higher than another monitoring circuitry, when a motor vehicle is in a state of stopping according to the state management circuitry;
the monitoring management circuitry determines, in accordance with a state of a process work-load according to the state management circuitry in the control apparatus, any one monitoring method by a combination made among monitoring on only the memory monitoring circuitry, monitoring on only the memory monitoring circuitry and the communications monitoring circuitry, monitoring on only the memory monitoring circuitry and the process monitoring circuitry, and monitoring on the memory monitoring circuitry, the communications monitoring circuitry and the process monitoring circuitry; and also
the monitoring management circuitry determines a monitoring method of a memory of a control value in the memory monitoring circuitry and that of control processing therein.

24. The control apparatus as set forth in claim 12, wherein
the monitoring management circuitry assigns a degree of priority of the memory monitoring circuitry higher than another monitoring circuitry, when a motor vehicle is in a state of stopping according to the state management circuitry;
the monitoring management circuitry determines, in accordance with a state of a process work-load according to the state management circuitry in the control apparatus, any one monitoring method by a combination made among monitoring on only the memory monitoring circuitry, monitoring on only the memory monitoring circuitry and the communications monitoring circuitry, monitoring on only the memory monitoring circuitry and the process monitoring circuitry, and monitoring on the memory monitoring circuitry, the communications monitoring circuitry and the process monitoring circuitry; and also
the monitoring management circuitry determines a monitoring method of a memory of a control value in the memory monitoring circuitry and that of control processing therein.

25. The control apparatus as set forth in claim 13, wherein
the monitoring management circuitry assigns a degree of priority of the memory monitoring circuitry higher than another monitoring circuitry, when a motor vehicle is in a state of stopping according to the state management circuitry;
the monitoring management circuitry determines, in accordance with a state of a process work-load according to the state management circuitry in the control apparatus, any one monitoring method by a combination made among monitoring on only the memory monitoring circuitry, monitoring on only the memory monitoring circuitry and the communications monitoring circuitry, monitoring on only the memory monitoring circuitry and the process monitoring circuitry, and monitoring on the memory monitoring circuitry, the communications monitoring circuitry and the process monitoring circuitry; and also
the monitoring management circuitry determines a monitoring method of a memory of a control value in the memory monitoring circuitry and that of control processing therein.

26. The control apparatus as set forth in claim 14, wherein
the monitoring management circuitry assigns a degree of priority of the memory monitoring circuitry higher than another monitoring circuitry, when a motor vehicle is in a state of stopping according to the state management circuitry;
the monitoring management circuitry determines, in accordance with a state of a process work-load according to the state management circuitry in the control apparatus, any one monitoring method by a combination made among monitoring on only the memory monitoring circuitry, monitoring on only the memory monitoring circuitry and the communications monitoring circuitry, monitoring on only the memory monitoring circuitry and the process monitoring circuitry, and monitoring on the memory monitoring circuitry, the communications monitoring circuitry and the process monitoring circuitry; and also
the monitoring management circuitry determines a monitoring method of a memory of a control value in the memory monitoring circuitry and that of control processing therein.

27. The control apparatus as set forth in claim 10, wherein the abnormality determination circuitry compares respective normal values of monitoring values to become as monitoring subject matters with respect to the process monitoring circuitry, the communications monitoring circuitry and the memory monitoring circuitry with a monitoring result of the process monitoring circuitry, with that of the communications monitoring circuitry and with that of the memory monitoring circuitry; and the abnormality determination circuitry performs determination so that the control apparatus is abnormal, when the respective normal values are not coincident with each other.

28. The control apparatus as set forth in claim 11, wherein
the state management circuitry acquires a state whether or not a motor vehicle receives cyber-security attack, whereby
the state management circuitry takes on a communications attack state when abnormality is determined by the abnormality determination circuitry in accordance with a monitoring result of the communications monitoring circuitry, and the monitoring management circuitry assigns a degree of priority of the communications monitoring circuitry higher than another monitoring circuitry;
the state management circuitry takes on a process attack state when abnormality is determined by the abnormality determination circuitry in accordance with a monitoring result of the process monitoring circuitry, and the monitoring management circuitry assigns a degree of priority of the process monitoring circuitry higher than another monitoring circuitry; and
the state management circuitry takes on a memory attack state when abnormality is determined by the abnormality determination circuitry in accordance with a monitoring result of the memory monitoring circuitry, and the monitoring management circuitry assigns a degree of priority of the memory monitoring circuitry higher than another monitoring circuitry.

29. The control apparatus as set forth in claim 12, wherein
the state management circuitry acquires a state whether or not a motor vehicle receives cyber-security attack, whereby
the state management circuitry takes on a communications attack state when abnormality is determined by the abnormality determination circuitry in accordance with a monitoring result of the communications monitoring circuitry, and the monitoring management circuitry assigns a degree of priority of the communications monitoring circuitry higher than another monitoring circuitry;
the state management circuitry takes on a process attack state when abnormality is determined by the abnormality determination circuitry in accordance with a monitoring result of the process monitoring circuitry, and the monitoring management circuitry assigns a degree of priority of the process monitoring circuitry higher than another monitoring circuitry; and
the state management circuitry takes on a memory attack state when abnormality is determined by the abnormality determination circuitry in accordance with a monitoring result of the memory monitoring circuitry, and the monitoring management circuitry assigns a degree of priority of the memory monitoring circuitry higher than another monitoring circuitry.
